(19) United States
(12) Patent Application Publication
(10) Pub. No.: US 2022/0193571 A1
(43) Pub. Date: Jun. 23, 2022

(54) PLATE CONNECTING ASSEMBLY

(71) Applicant: XROBO CO.,LTD., Ulsan (KR)

(72) Inventors: Su Hyeon LIM, Ulsan (KR); Byung Jin CHOI, Ulsan (KR)

(21) Appl. No.: 17/606,146

(22) PCT Filed: Jul. 30, 2020
(86) PCT No.: PCT/KR2020/010069

§ 371 Date: Oct. 25, 2021

(30) Foreign Application Priority Data
Aug. 22, 2019 (KR) 10-2019-0102940

(51) Int. Cl. A63H 33/10; A63H 33/04

(52) U.S. Cl. CPC A63H 33/107; A63H 33/042

(57) ABSTRACT

A plate connecting assembly according to an embodiment includes a first frame, with an upper portion and a lower portion of the first frame making a predetermined angle with each other, and a second frame having a first support portion facing the upper portion and a second support portion facing the lower portion. In the plate connecting assembly, a first fixation-subject object is fixed between the upper portion and the first support portion, a second fixation-subject is fixed between the lower portion and the second support portion, and thus the first and second fixation-subject objects are fixed in such a manner that an angle therebetween is the same as an angle that the upper portion and the lower portion make with each other.

### CROSS REFERENCE TO RELATED APPLICATIONS AND CLAIM OF PRIORITY

This application claims benefit under 35 U.S.C. 119(e), 120, 121, or 365(c), and is a National Stage entry from International Application No. PCT/KR2020/010069, filed Jul. 30, 2020, which claims priority to the benefit of Korean Patent Application No. 10-2019-0102940 filed in the Korean Intellectual Property Office on Aug. 22, 2019, the entire contents of which are incorporated herein by reference.

### BACKGROUND

### 1. Technical Field

The present invention relates to a plate connecting assembly.

### 2. Background Art

In recent years, block play games for children or for hobby use have competed with games on electronic products, such as smartphones and smart TVs, that preferentially attract the attention of children or adults. In order to positively draw the interest and concern of children and adults, various types of blocks that, when reassembled, can perform electrical and mechanical operations at the same time in addition to simply providing a sense of achievement in reassembling blocks have been under development.

Particularly, while a robot is assembled using blocks capable of performing the electrical and mechanical operations at the same time, much can be learned about electric circuits and mechanical components for performing the electrical least and mechanical operations that are included in the robot. For this reason, robot assembling games have attracted much attention.

A plurality of components are assembled to realize a movable robot. Specifically, a plurality of plates, such as a plate for mounting an indispensable drive unit, such as a motor, and a plate for realizing a shape of a robot, are connected to each other. At this point, a connection bracket is used to connect the plurality of plates to each other.

In the related art, the connection bracket can connect plates to each other only in the vertical direction. That is, one plate is connected to one surface of a “L”-shaped connection bracket, and other one plate is connected to the other surface thereof. This connection method provides the disadvantage that two different plates can be connected to each other only in the vertical direction. Therefore, there is a need for brackets for connecting and assembling the plurality of plates according to a finished shape of the robot.

### SUMMARY

Embodiments of the present invention are to provide a plate connecting assembly capable of connecting and assembling a plurality of plates in such a manner that the plurality of plates makes various angles with each other.

According to an aspect of the present invention, there is provided a plate connecting assembly including: a first frame, with an upper portion and a lower portion of the first frame making a predetermined angle with each other; and a second frame having a first support portion facing the upper portion and a second support portion facing the lower portion, wherein a first fixation-subject object is fixed between the upper portion and the first support portion, a second fixation-subject is fixed between the lower portion and the second support portion, and thus the first and second fixation-subject objects are fixed in such a manner that an angle therebetween is the same as an angle that the upper portion and the lower portion make with each other.

In the plate connecting assembly, fixation portions may be formed to protrude from the upper portion and the lower portion, respectively, and pressing portions may be formed to protrude at respective positions, respectively, on the first support portion and the second support portion, the respective positions facing the fixation portions, respectively.

In the plate connecting assembly, an alignment portion may be formed to a shape of a portion recessed into a lateral surface of the first frame or to a shape of a portion protruding therefrom, and a combination portion may be formed to a shape of a portion recessed into a lateral surface of the second frame or to a shape of a portion protruding therefrom, the combination portion being engaged with the alignment portion formed on or in the first frame.

In the plate connecting assembly, the first frame may include a fastening groove through which a fastening member passes for being fastened, and the second frame may include a fastening hole through which the fastening member passing through the first frame passes for being fastened.

In the plate connecting assemble, a separation distance between the fixation portion and the pressing portion may be adjusted according to depths to which the fastening member is inserted into the fastening groove and the fastening hole, respectively.

According to embodiments of the present invention, a plurality of plates can be connected and assembled in such a manner that the plurality of plates make various angles with each other.

### BRIEF DESCRIPTION OF THE DRAWINGS

FIG. 1 is an exploded view illustrating a state where a plate connecting assembly according to a first embodiment of the present invention is disassembled;

FIG. 2 is a view illustrating a state where the plate connecting assembly in FIG. 1 is reassembled;

FIGS. 3 and 4 are views each illustrating a first frame in FIG. 1;

FIGS. 5 and 6 are views each illustrating a second frame in FIG. 1;

FIG. 7 is a view illustrating another implementation example of each of an alignment portion and a combination portion in FIG. 1;

FIG. 8 is a view illustrating an implementation example where in the plate connecting assembly according to the first embodiment, an angle between an upper portion and a lower portion is changed;

FIG. 9 is a view illustrating another implementation example where in the plate connecting assembly according to the first embodiment, the angle between the upper portion and the lower portion is changed;

FIGS. 10 and 11 are views illustrating a first frame and a second frame, respectively, in FIG. 9;

FIG. 12 is a view illustrating a plate connecting assembly according to a second embodiment of the present invention;

FIGS. 13 and 14 are views each illustrating a first frame of the plate connecting assembly according to the second embodiment;

FIGS. 15 and 16 are views illustrating a second frame of the plate connecting assembly according to the second embodiment.

FIG. 17 is a view illustrating an implementation example where in the plate connecting assembly according to the second embodiment, an angle between an upper portion and a lower portion is changed; and

FIG. 18 is a view illustrating another implementation example where in the plate connecting assembly according to the second embodiment, the angle between the upper portion and the lower portion is changed.

### DETAILED DESCRIPTION

Specific embodiments of the present invention will be described below with reference to the drawings. However, the specific embodiments are only exemplary, and the present invention is not limited to the specific embodiments.

A detailed description of a technology known in the related will be omitted below when determined as making the nature and gist of the present invention unclear. Terms defined by considering functions according to the present invention will be used throughout the specification, but other terms may be used according to the intention of a user or a manager, or according to the common practices in the art or the like. Therefore, the terms used should be construed in light of the present specification.

The scope of the present invention is defined by the claims, and the following embodiments are provided to describe the inventive new technical idea of the present invention in a manner that is understandable to a person of ordinary skill in the art to which the present invention pertains.

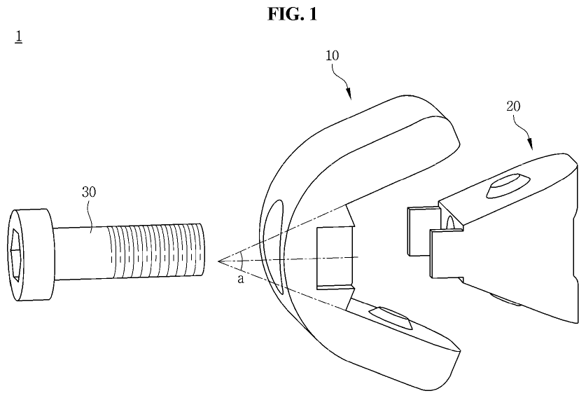

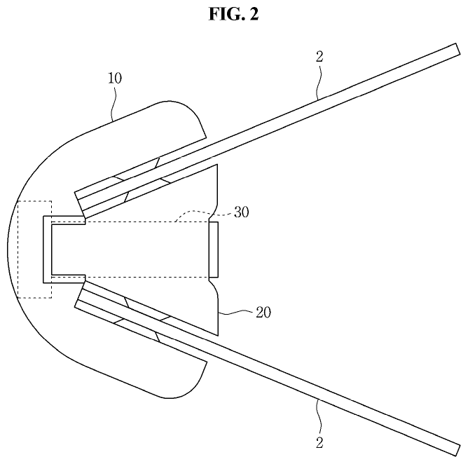

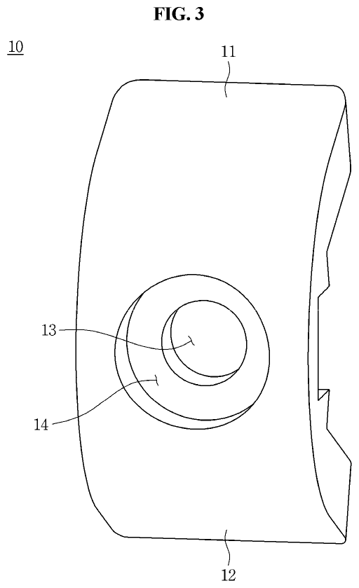

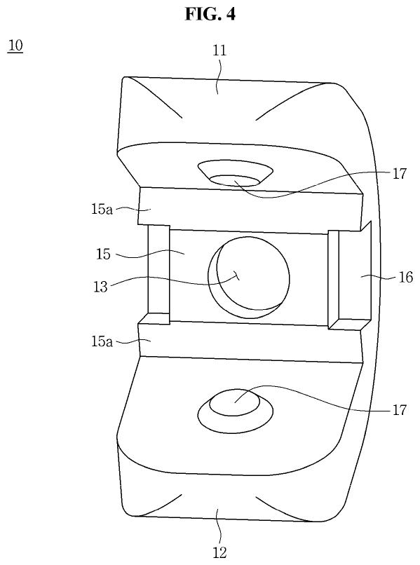

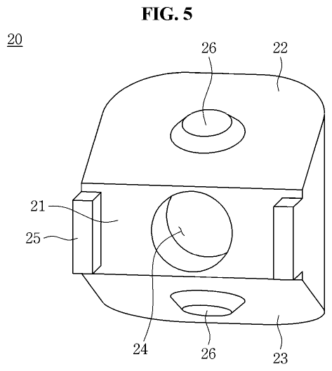

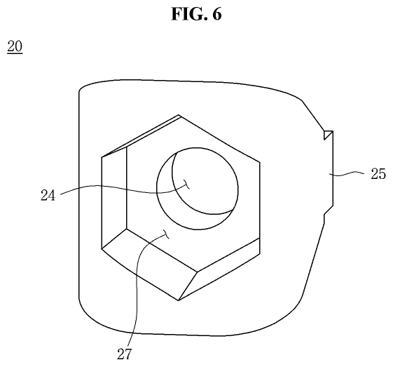

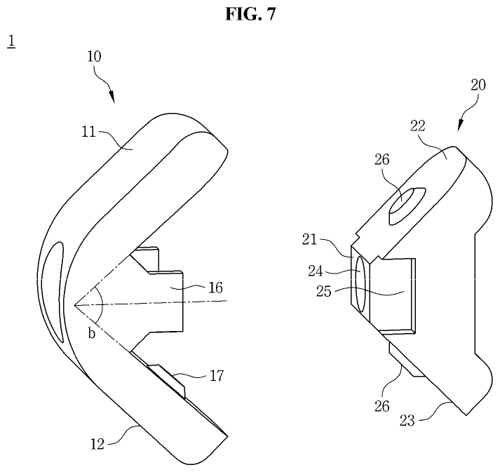

FIG. 1 is an exploded view illustrating a state where a plate connecting assembly 1 according to a first embodiment of the present invention is disassembled. FIG. 2 is a view illustrating a state where the plate connecting assembly 1 in FIG. 1 is reassembled. FIGS. 3 and 4 are views each illustrating a first frame 10 in FIG. 1. FIGS. 5 and 6 are views each illustrating a second frame 20 in FIG. 1. FIG. 7 is a view illustrating another implementation example of each of an alignment portion 16 and a combination portion 25 in FIG. 1.

With reference to FIGS. 1 to 7, the plate connecting assembly 1 may include the first frame 10 and the second frame 20. The first frame 10 and the second frame 20 may be fastened to each other by a fastening member.

FIG. 1 is the view illustrating the state where the plate connecting assembly is disassembled into the first frame 10, the second frame 20, and the fastening member. FIG. 2 is the view illustrating the state where the first frame 10 and the second frame 20 are fastened to each other by the fastening member. With reference to FIG. 2, a fixation-subject object 2 may be fixed by being inserted between the first frame 10 and the second frame 20. Specifically, with a force that keeps the fastening member pressed against the first frame 10 and the second frame 20, the fixation-subject object 2 may be fixed between the first frame 10 and the second frame 20. As an example, the fixation-subject object 2 may be a plate. That is, the fixation-subject object 2 may be a bracket in the form of a plate.

Depths to which the fastening member is inserted into a first fastening hole 13 and a second fastening hole 24, respectively, may be adjusted according to a thickness of the fixation-subject object 2 fixed between the first frame 10 and the second frame 20.

First, with reference to FIGS. 3 and 4, the first frame 10 may include an upper portion 11, a lower portion 12, the first fastening hole 13, a fastening groove 14, a protrusion portion 15, an inclination surface 15a, the alignment portion 16, and a fixation portion 17.

The upper portion 11 and the lower portion 12 of the first frame 10 may make a predetermined angle to each other. The first frame 10, as illustrated in FIG. 1, may be formed to be bent in such a manner that the upper portion 11 and the lower portion 12 thereof are inclined inward. That is, the first frame 10 may be formed to be bent in such a manner that respective internal surfaces of the upper portion 11 and the lower portion 12 face each other. The upper portion 11 and the lower portion 12 may make an angle of a with each other. As an example, a may be 45 degrees.

The fastening member may pass through the first fastening hole 13 for being fastened. As an example, the first fastening hole 13 may be formed in a center portion of the first frame 10. That is, the first fastening hole 13 may be formed in the center portion of the first frame 10 between the upper portion 11 and the lower portion 12. Therefore, the center of gravity of the fixation-subject object 2 may be set not to move in a state where the fixation-subject object 2 is fastened to the first frame 10 and the second frame 20.

The fastening groove 14 may be a groove that is concentrically formed along an edge of the first fastening hole 13 in an external surface of the first frame 10. For example, in a case where the fastening member is a bolt, a bolt head nested in the fastening groove 14 may not protrude outward from the external surface of the first frame 10.

The protrusion portion 15 may be formed to protrude from an internal surface of the first frame 10. As an example, the protrusion portion 15 may be formed on a portion between the upper portion 11 and the lower portion 12 where the first fastening hole 13 is formed.

In this case, the inclination surface 15a may be formed between the protrusion portion 15 and the upper portion 11. An end portion of the fixation-subject object 2 that is inserted according to an angle of inclination of the upper portion 11 may be brought into contact with the inclination surface 15a. That is, the end portion of fixation-subject object 2 that is inserted may be supported on the inclination surface 15a.

When the first frame 10 and the second frame 20 are fastened to each other, the alignment portion 16 may guide alignment of the first frame 10 and the second frame 20 for fastening at home positions thereof. Combination of the alignment portion 16 with the combination portion 25 formed on or in the second frame 20 may fasten the first frame 10 and the second frame 20 to each other while maintaining the alignment thereof.

The alignment portion 16 may be formed to a shape of a portion recessed into a lateral surface of the first frame 10 or to a shape of a portion protruding therefrom. FIGS. 1 to 6 illustrate that the alignment portion 16 is formed to the shape of the recessed portion. The alignment portion 16 may be formed to a shape of a groove. In this case, the combination portion 25 of the second frame 20 may be formed to a shape of a protruding portion, that is, to a shape of a protrusion.

In contrast, FIG. 7 illustrates that the alignment portion 16 is formed to the shape of the protruding portion. The alignment portion 16 may be formed to a shape of a protrusion. In this case, the combination portion 25 of the second frame 20 may be formed in a shape of a recessed portion, that is, to a shape of a groove.

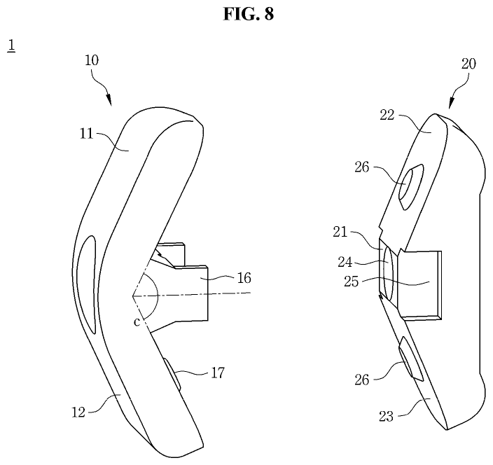

FIGS. 1 to 6 illustrate that the alignment portion 16 is formed to the shape of the recessed portion and that the combination portion 25 is formed to the shape of the protruding portion. FIG. 8 and subsequent figures illustrate that the alignment portion 16 is formed to the shape of the protruding portion and that the combination portion 25 is formed to the shape of the recessed portion.

The fixation portion 17 may be formed to protrude from each of the respective internal surfaces of the upper 11 and the lower portion 12. Specifically, the fixation portion 17 formed on the internal surface of the upper portion 11 may press the fixation-subject object 2 inserted between the internal surface of the upper portion 11 and first support portion 22 of the second frame 20, thereby increasing a force that keeps the fixation-subject object 2 in place.

Likewise, the fixation portion 17 formed on the internal surface of the lower portion 12 may press the fixation-subject object 2 inserted between the internal surface of the lower portion 12 and a second support portion 23 of the second frame 20, thereby increasing a force that keeps the fixation-subject object 2 in place.

In addition, the fixation portion 17 formed to protrude from the internal surface of the upper portion 11 may press the fixation-subject object 2. Thus, a first elastic fixation-subject object 2 is flexible within a separation distance between the internal surface of the upper portion 11 of the first frame 10 and the first support portion 22 of the second frame 20 and accordingly may be flexibly fastened along with a second fixation-subject object 2.

With reference back to FIGS. 5 and 6, the second frame 20 may include a front portion 21, a first support portion 22, the second support portion 23, the second fastening hole 24, the combination portion 25, a pressing portion 26, and a groove portion 27.

The front portion 21 may be a portion of the frame 20 that is brought into contact with the protrusion portion 15 of the first frame 10.

The first support portion 22 may be in the shape of a triangle prism having two right-angled triangle bases and may be arranged on an upper surface of the front portion 21. An inclination surface of the first support portion 22 may be inclined upward at a predetermined angle with respect to the upper surface of the front portion 21. The second support portion 23 may be in the shape of a triangle prism having two right-angled triangle bases and may be arranged on a lower surface of the front portion 21. An inclination surface of the second support portion 23 may be inclined downward at a predetermined angle with respect to the lower surface of the front portion 21.

The first support portion 22 and the second support portion 23 may be arranged to face the internal surface of the upper portion 11 and the internal surface of the lower portion 12, respectively, when the first frame 10 and the second frame 20 are fastened to each other.

The inclination surface of the first support portion 22 is inclined in such a manner as to correspond to an angle of downward inclination of the upper portion 11 of the first frame 10. The inclination surface of the second support portion 23 may be inclined in such a manner as to correspond to an angle of upward inclination of the lower portion 12 thereof. When an angle between the upper portion 11 and the lower portion 12 is a, the inclination surface of the first support portion 22 and the inclination surface of the second support portion 23 may make an angle of a with each other.

The first fixation-subject object 2 may be inserted between the first support portion 22 and the upper portion 11 that are arranged a predetermined distance apart from each other in such a manner as to face each other. The second fixation-subject object 2 may be inserted between the second support portion 23 and the lower portion 12 that are arranged a predetermined distance apart from each other in such a manner as to face each other. Therefore, with the first frame 10 and the second frame 20, the first and second fixation-subject objects 2 may be held in place. Therefore, the first and second fixation-subjects 2 may be held in place in such a manner that an angle therebetween is the same as an angle that the upper portions 11 and the lower portion 12 make with each other.

The fastening member passing through the first fastening hole 13 in the first frame 10 may be inserted into the second fastening hole 24 for being fastened. The second fastening hole 24 may be formed in the front portion 21. As an example, the second fastening hole 24 may be formed in a center portion of the second frame 20 between the first support portion 22 and the second support portion 23.

A separation distance between the fixation portion 17 and the pressing portion 26 may be adjusted according to the depths to which the fastening member is inserted into the first fastening hole 13 and the second fastening hole 24, respectively. That is, the depths to which the fastening member is inserted into the first fastening hole 13 and the second fastening hole 24, respectively, may be adjusted according to a thickness of the fixation-subject object 2 that is fixed between the first frame 10 and the second frame 20.

When the first frame 10 and the second frame 20 are fastened to each other, the combination portion 25 may guide the alignment of the first frame 10 and the second frame 20 for fastening at the home positions thereof. Combination of the combination portion 25 with the alignment portion 16 formed in or on the first frame 10 may fasten the first frame 10 and the second frame 20 to each other while maintaining the alignment thereof.

The combination portion 25 may be formed to the shape of the recessed portion or to the shape of the protruding portion. Correspondingly, the alignment portion 16 may be formed to the shape of the protruding portion or the shape of the recessed portion. Thus, the combination portion 25 and the alignment portion 16 may be engaged with each other.

The pressing portion 26 may be formed to protrude from each of the first support portion 22 and the second support portion 23. The pressing portion 26 may be formed to protrude at a position for facing the protrusion portion 15 of the first frame 10.

The first fixation-subject object 2 inserted between the internal surface of the upper portion 11 and first support portion 22 may be pressed by the pressing portion 26 and the protrusion portion 15 and thus may be held in place. The second fixation-subject object 2 inserted between the internal surface of the lower portion 12 and a second support portion 23 may be pressed by the pressing portion 26 and the protrusion portion 15 and thus may be held in place.

The fastening groove 27 may be a groove that is concentrically formed along an edge of the second fastening hole 24 in an external surface of the second frame 20. For example, in a case where the fastening member is a bolt, a bolt end portion nested in the groove portion 27 may not protrude outward from an external surface of the second frame 20.

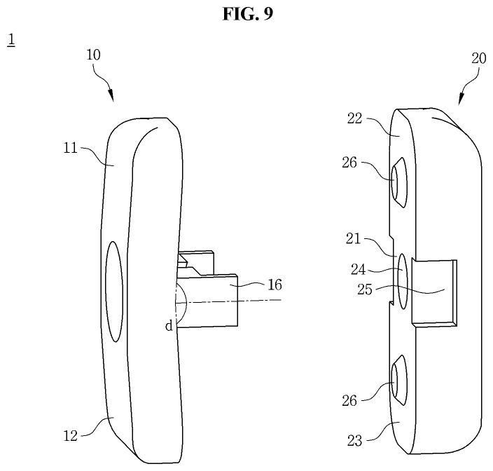

FIG. 8 is a view illustrating an implementation example where in the plate connecting assembly 1 according to the first embodiment, the angle between the upper portion 11 and the lower portion 12 is changed. FIG. 9 is a view illustrating another implementation example where in the plate connecting assembly 1 according to the first embodiment, the angle between the upper portion 11 and the lower portion 12 is changed.

With reference to FIGS. 8 and 9, the upper portion 11 and the lower portion 12 of the first frame 10 may be formed in various shapes in such a manner that the angle therebetween is changed.

As a first example, FIG. 1 illustrates that the upper portion 11 and the lower portion 12 may be formed in such a manner that the angle therebetween is a (for example, 45 degrees. FIG. 7 illustrates that the upper portion 11 and the lower portion 12 may be formed in such a manner that the angle therebetween is b (for example, 90 degrees). FIG. 8 illustrates that the upper portion 11 and the lower portion 12 may be formed in such a manner that the angle therebetween is c (for example, 135 degrees). FIG. 9 illustrates that the upper portion 11 and the lower portion 12 may be formed in such a manner that the angle therebetween is d (for example, 180 degrees).

In these cases, the first support portion 22 and the second support portion 23 of the second frame 20 may be formed in such a manner that the angle between the respective inclination surfaces of the first support portion 22 and the second support portion 23 corresponds the angle that the upper portion 11 and the lower portion 12 of the first frame 10 make with each other. For example, the upper portion 11 of the first frame 10 and the first support portion 22 of the second frame 20 may be formed in such a manner as to be in parallel with each other. The lower portion 12 of the first frame 10 and the second support portion 23 of the second frame 20 may be formed in such a manner as to be in parallel with each other.

In this manner, an angle between different plates, that is, the first and second fixation-subject objects 2 that are fixed to the plate connecting assembly 1 may be determined according to the angle that the upper portion 11 and the lower portion 12 of the first frame 10 make with each other and the angle that the inclination surfaces of the first support portion 22 and the second support portion 23 of the second frame 20 make with each other.

For example, as illustrated in FIG. 9, different plates, that is, the first and second fixation-subject objects 2 that are fixed to the plate connecting assembly 1 in which the upper portion 11 and the lower portion 12 make an angle of c with each other may be fixed in such a manner as to make an angle c with each other.

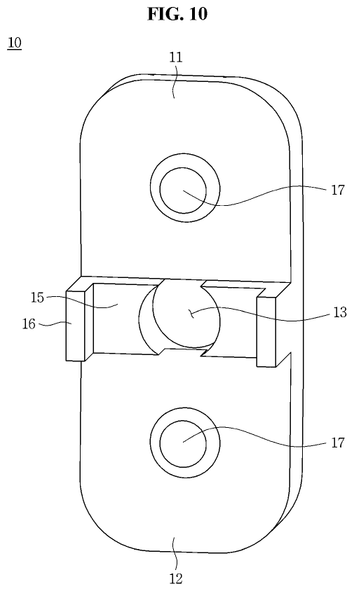

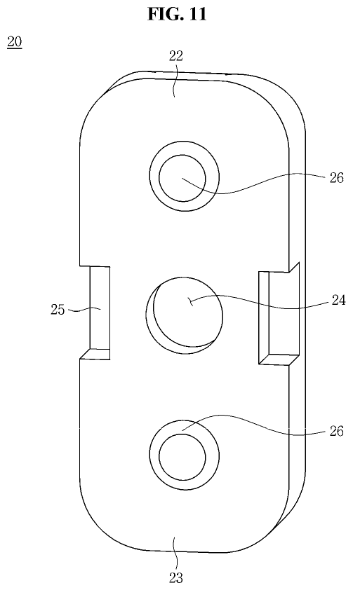

FIGS. 10 and 11 are views illustrating a first frame 10 and a second frame 20, respectively, in FIG. 9.

FIG. 10 illustrates a case where the upper portion 11 and the lower portion 12 are formed to be positioned on the same flat plane. FIG. 11 illustrates a case where the first support portion 22 and the second support portion 23 are formed to be positioned on the same flat plane. In this case, different plates, that is, the first and second fixation-subject objects 2 may be fixed in such a manner that an angle therebetween is 180 degrees.

In this case, in addition, the inclination surface 15a may not be formed separately.

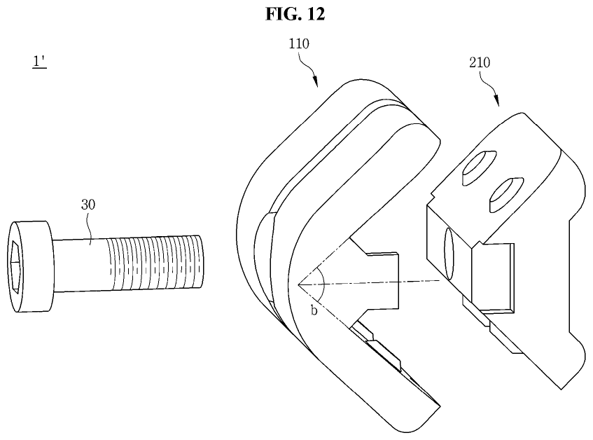

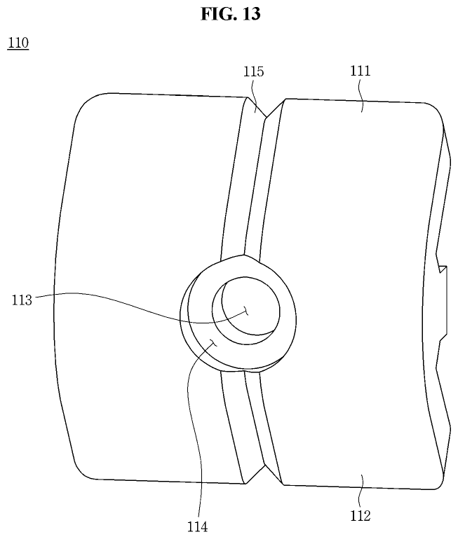

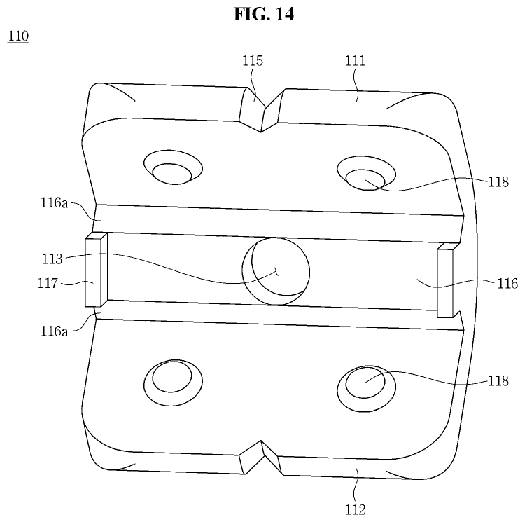

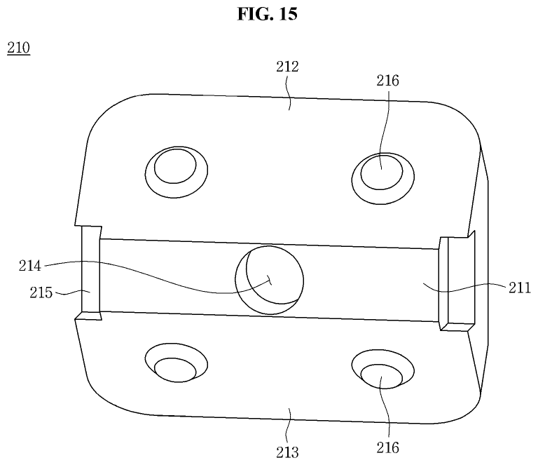

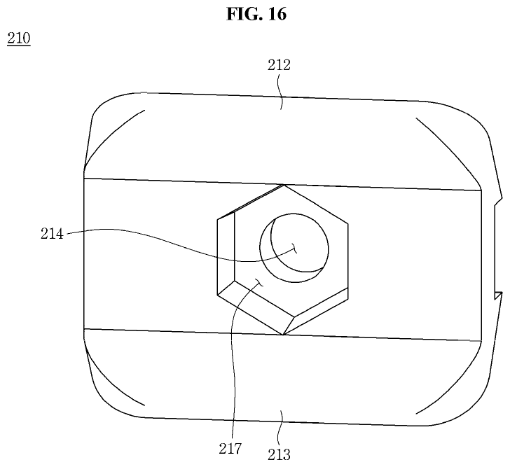

FIG. 12 is a view illustrating a plate connecting assembly 1′ according to a second embodiment of the present invention. FIGS. 13 and 14 are views each illustrating a first frame 10 of the plate connecting assembly according to the second embodiment. FIGS. 15 and 16 are views illustrating a second frame 20 of the plate connecting assembly according to the second embodiment.

With reference to FIGS. 12 to 16, it is possible that a width or a length of the plate connecting assemble 1′ is increased or decreased. As an example, the plate connecting assemble 1′ according to the second embodiment in FIGS. 12 to 16 is formed to have an increased width (that is, an increased distance between one lateral surface to the other lateral surface), compared with the above-described plate connecting assemble 1 according to the first embodiment.

Only a difference with the above-described plate connecting assemble 1 according to the first embodiment will be described below.

The first frame 10 may further include an elastic groove 115. The elastic groove 115 may be formed along the centerline of an external surface of the first frame 10 and may be a groove formed in such a manner that opposite sides of the first frame 10 have an elastic force.

In a case where the first frame 10 is formed to have a great width, a plurality of fixation portions 118 may be formed in each of an upper portion 111 and a lower portion 112. As an example, two fixation portions 118 may be formed on the upper portion 111 in such a manner as to be arranged a distance apart from each other, and other two fixation portions 118 may be formed on the lower portion 112 in such a manner as to be arranged a distance apart from each other.

Likewise, a plurality of pressing portions 216 may be formed on each of a first support portion 212 and a second support portion 213 of the second frame 20. As an example, two pressing portions 216 may be formed on the first support portion 212 in such a manner as to be arranged a distance apart from each other, and other two pressing portions 216 may be formed on the second support portion 213 in such a manner as to be arranged a distance apart from each other.

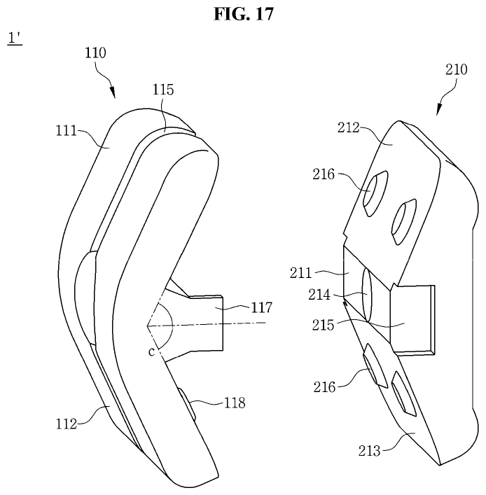

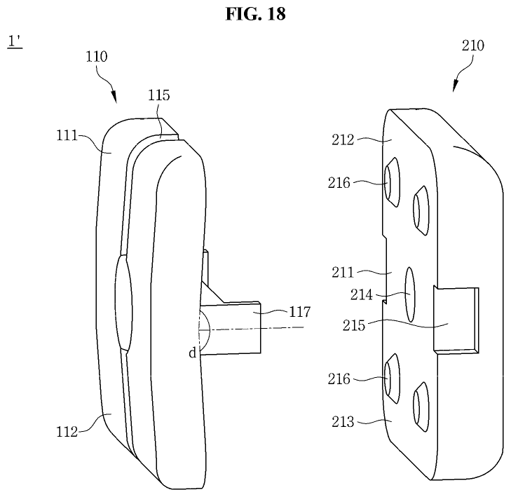

FIG. 17 is a view illustrating an implementation example where in the plate connecting assembly 1′ according to the second embodiment, an angle between the upper portion 111 and the lower portion 112 is changed. FIG. 18 is a view illustrating another implementation example where in the plate connecting assembly 1′ according to the second embodiment, the angle between the upper portion 111 and the lower portion 112 is changed.

With reference to FIGS. 17 and 18, the upper portion 111 and the lower portion 112 of the first frame 10 may be formed in various shapes in such a manner that the angle therebetween is changed.

FIG. 12 illustrates that the upper portion 111 and the lower portion 112 may be formed in such a manner that the angle therebetween is b (for example, 90 degrees. FIG. 17 illustrates that the upper portion 111 and the lower portion 112 may be formed in such a manner that the angle therebetween is c (for example, 135 degrees). FIG. 18 illustrates that the upper portion 111 and the lower portion 112 may be formed in such a manner that the angle therebetween is d (for example, 180 degrees).

In this manner, an angle between the first and second fixation-subjects 2 fixed to the plate connecting assembly 1′ may be determined according to the angle that the upper portion 111 and the lower portion 112 of the first frame 10 make with each other and an angle that respective angles of inclination surfaces of the first support portion 212 and the second support portion 213 of the second frame 20 make with each other.

The present invention is described above in an illustrative manner. In addition, the desired embodiments of the present invention are described above, and various different combinations of and various different modifications to the embodiments of the present invention may be made under various conditions. Modifications or alterations to the embodiments of the invention are possible within the scope of the concept of the invention disclosed in the present specification, the scope of equivalents of the described contents in the present specification, and/or the scope of technology or knowledge in the art. Optimal requirements for realizing the technical idea of the present invention are described for the embodiments. Various modifications that are required in the field in which the present invention finds application and that are required to make or use the present invention are possible as well. Therefore, in the detailed description of the present invention, the embodiments as disclosed are not intended to impose any limitation to the present invention. In addition, the following claims should be construed to cover other embodiments as well.

1. A plate connecting assembly comprising:
a first frame, with an upper portion and a lower portion of the first frame making a predetermined angle with each other; and
a second frame having a first support portion facing the upper portion and a second support portion facing the lower portion,
wherein a first fixation-subject object is fixed between the upper portion and the first support portion, a second fixation-subject is fixed between the lower portion and the second support portion, and thus the first and second fixation-subject objects are fixed in such a manner that an angle therebetween is the same as an angle that the upper portion and the lower portion make with each other.

2. The plate connecting assembly of claim 1, wherein fixation portions are formed to protrude from the upper portion and the lower portion, respectively, and pressing portions are formed to protrude at respective positions, respectively, on the first support portion and the second support portion, the respective positions facing the fixation portions, respectively.

3. The plate connecting assembly of claim 2, wherein an alignment portion is formed to a shape of a portion recessed into a lateral surface of the first frame or to a shape of a portion protruding therefrom, and a combination portion is formed to a shape of a portion recessed into a lateral surface of the second frame or to a shape of a portion protruding therefrom, the combination portion being engaged with the alignment portion formed on or in the first frame.

4. The plate connecting assembly of claim 3, wherein the first frame includes a fastening groove through which a fastening member passes for being fastened, and the second frame includes a fastening hole through which the fastening member passing through the first frame passes for being fastened.

5. The plate connecting assemble of claim 4, wherein a separation distance between the fixation portion and the pressing portion is adjusted according to depths to which the fastening member is inserted into the fastening groove and the fastening hole, respectively.
